(19) United States
(12) Patent Application Publication
(10) Pub. No.: US 2008/0265205 A1
(43) Pub. Date: Oct. 30, 2008

(54) Polishing Composition

(75) Inventors: Junhui Oh, Seoul (KR); Hiroshi Asano, Kakamigahara-shi (JP); Katsunobu Hori, Inuyama-shi (JP)

Correspondence Address: VIDAS, ARRETT & STEINKRAUS, P.A., SUITE 400, 6640 SHADY OAK ROAD, EDEN PRAIRIE, MN, 55344, US

(73) Assignee: FUJIMI INCORPORATED, Kiyosu-shi (JP)

(21) Appl. No.: 12/065,419

(22) PCT Filed: Sep. 1, 2006
(86) PCT No.: PCT/JP2006/317305

§ 371 Date: Feb. 29, 2008

(30) Foreign Application Priority Data
Sep. 2, 2005 (JP) 2005-255535

(51) Int. Cl. C09K 13/00

(52) U.S. Cl. 252/79.1

(57) ABSTRACT

A polishing composition contains a protective film forming agent, an oxidant, and an etching agent. The protective film forming agent includes at least one type of compound selected from benzotriazole and a benzotriazole derivative and at least one type of compound selected from the compounds represented by the general formula ROR′COOH and a general formula ROR′OPO₃H₂ where R represents an alkyl group or an alkylphenyl group, R′ represents a polyoxyethylene group, polyoxypropylene group, or poly(oxyethylene/oxypropylene) group. The pH of the polishing composition is 8 or more. The polishing composition is suitably used in polishing for forming wiring of a semiconductor device.

### TECHNICAL FIELD

The present invention relates to a polishing composition to be used in polishing, for example, for forming wiring of a semiconductor device.

### BACKGROUND ART

The wiring of a semiconductor device is formed first by forming a barrier layer and a conductive layer successively in this order on an insulating layer having trenches. Then, at least a portion of the conductive layer (outer portion of the conductive layer) positioned outside the trenches and a portion of the barrier layer (outer portion of the barrier layer) positioned outside the trenches are removed by chemical mechanical polishing. The polishing for removing at least the outer portion of the conductive layer and the outer portion of the barrier layer is usually performed by two separate steps: a first polishing step and a second polishing step. In the first polishing step, the outer portion of the conductive layer is partly removed to expose the upper surface of the barrier layer. In the following second polishing step, at least the remaining outer portion of the conductive layer and the outer portion of the barrier layer are removed to expose the insulating layer and obtain a planer surface.

When a portion of the conductive layer except a portion of the conductive layer to be removed, in particular, a portion of the conductive layer (inner portion of the conductive layer) positioned within trenches is removed, dishing occurs, which is a phenomenon where the level of the upper surface of the conductive layer decreases. As a result, wire resistance increases and surface flatness decreases. For the reasons, Patent Documents 1 and 2 each disclose an improved polishing composition that is usable in the first polishing step and suppresses dishing. More specifically, Patent Documents 1 and 2 each disclose a polishing composition containing a protective film forming agent such as benzotriazole, an oxidant such as hydrogen peroxide, and an etching agent such as glycine. However, the polishing compositions of Patent Documents 1 and 2 fail to satisfy requirements with respect to dishing and still have room for improvement.

### Patent Document 1: Japanese Laid-Open Patent Publication No. 8-83780

Patent Document 2: International Publication No. WO 00/39844

### DISCLOSURE OF THE INVENTION

An objective of the present invention is to provide a polishing composition which is more suitably used in polishing for forming wiring of a semiconductor device.

To achieve the foregoing objective and in accordance with one aspect of the present invention, a polishing composition containing a protective film forming agent, an oxidant, and an etching agent is provided. The protective film forming agent is at least one type of compound selected from benzotriazole and a benzotriazole derivative and at least one type of compound selected from the compounds represented by the general formula ROR′COOH and the general formula ROR′OPO₃H₂ (where R represents an alkyl group or an alkylphenyl group, and R′ represents a polyoxyethylene group, polyoxypropylene group, or poly(oxyethylene/oxypropylene) group). The pH of the polishing composition is 8 or more.

### BRIEF DESCRIPTION OF THE DRAWINGS

FIGS. 1(a), 1(b), and 1(c) are cross-sectional views of an object to be polished for explaining a method for forming wiring of a semiconductor device; and

FIG. 2 is a cross-sectional view of an object to be polished for illustrating dishing.

### BEST MODE FOR CARRYING OUT THE INVENTION

One embodiment will now be explained below.

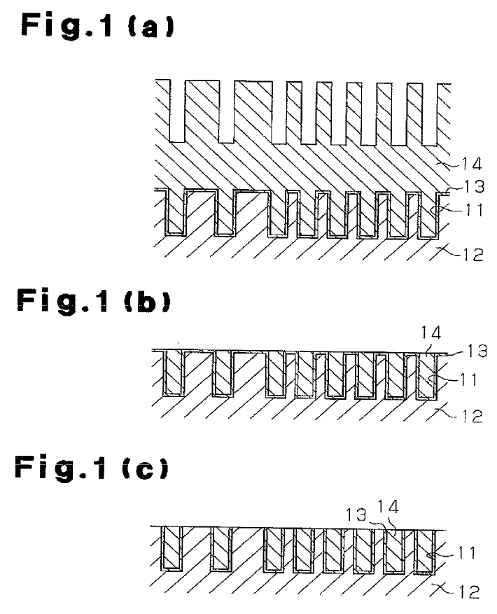

First, a method for forming wiring of a semiconductor device will be explained in accordance with FIGS. 1(a) to 1(c). The wiring of a semiconductor device is usually formed as follows. First, as shown in FIG. 1(a), on an insulating layer 12 formed on a semiconductor substrate (not shown) and having trenches 11, a barrier layer 13 and a conductive layer 14 are successively formed in this order. Thereafter, at least a portion of the conductive layer 14 (outer portion of the conductive layer 14) positioned outside the trenches 11 and a portion of the barrier layer 13 (outer portion of the barrier layer 13) positioned outside the trenches are removed by chemical mechanical polishing. As a result, as shown in FIG. 1(c), at least a part of a portion of the barrier layer 13 (inner portion of the barrier layer 13) positioned within the trenches 11 and at least a part of a portion of the conductive layer 14 (inner portion of the conductive layer 14) positioned within the trenches 11 remain on the insulating layer 12. The portion of the conductive layer 14 remaining on the insulating layer 12 comes to function as wiring of a semiconductor device.

The insulating layer 12 is formed of, for example, silicon dioxide, silicon dioxide doped with fluorine (SiOF), or silicon dioxide doped with carbon (SiOC).

Before the conductive layer 14 is formed, the barrier layer 13 is formed on the insulating layer 12 so as to cover over the surface of the insulating layer 12. The barrier layer 13 is formed of, for example, tantalum, a tantalum alloy, or tantalum nitride. The thickness of the barrier layer 13 is lower than the depth of the trenches 11.

After the barrier layer 13 is formed, the conductive layer 14 is formed on the barrier layer 13 so as at least to bury trenches 11. The conductive layer 14 is formed of, for example, copper or a copper alloy.

When at least the outer portion of the conductive layer 14 and the outer portion of the barrier layer 13 are removed by chemical mechanical polishing, first, the outer portion of the conductive layer 14 is partially removed so as to expose the upper surface of the outer portion of the barrier layer 13, as shown in FIG. 1(b) (first polishing step). Thereafter, as shown in FIG. 1(c), at least the remaining outer portion of the conductive layer 14 and the outer portion of the barrier layer 13 are removed so as to expose the insulating layer 12 and obtain a planar surface (second polishing step). A polishing composition of the embodiment is used in polishing for forming wiring of a semiconductor device, more specifically, particularly suitable for use in the first polishing step.

The polishing composition according to the embodiment is produced by blending predetermined amounts of a protective film forming agent, an oxidant, an etching agent (complex forming agent), abrasive grains, and water so as to obtain a pH of 8 or more. Accordingly, the polishing composition according to the embodiment is substantially composed of a protective film forming agent, an oxidant, an etching agent, abrasive grains, and water.

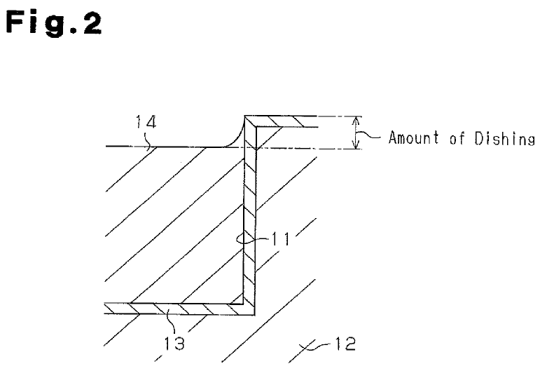

The protective film forming agent has a function of forming a protective film on the surface of an object to be polished and forms the protective film of the surface of the conductive layer 14 to suppress excessive removal of the inner portion of the conductive layer 14, thereby suppressing dishing (see FIG. 2).

The protective film forming agent to be contained in the polishing composition contains at least one type of compound selected from benzotriazole and a benzotriazole derivative, and at least one type of compound selected from compounds (anionic surfactants) represented by the general formula (1) and the general formula (2) below. In other words, the polishing composition contains a first protective film forming agent consisting of at least one type of compound selected from benzotriazole and a benzotriazole derivative, and a second protective film forming agent consisting of at least one type of compound selected from compounds represented by the general formula (1) and the general formula (2). The benzotriazole derivative is formed, for example, by replacing a hydrogen atom bonded to the 5-membered ring of benzotriazole with another atomic group.

ROR′COOH (1)

ROR′OPO₃H₂ (2)

In the formulas (1) and (2), R represents an alkyl group or an alkylphenyl group, and R′ represents a polyoxyethylene group, polyoxypropylene group, or poly(oxyethylene/oxypropylene) group.

The first protective film forming agent to be contained in the polishing composition is preferably benzotriazole to obtain a stronger dishing suppression function.

When the content of the first protective film forming agent in the polishing composition is less than 0.001 g/L, and more specifically less than 0.01 g/L, a protective film sufficient to suppress excessive polishing of the conductive layer 14 may not be formed on the surface of the conductive layer 14. As a result, dishing is not sufficiently suppressed or the conductive layer 14 may have a rough surface. Accordingly, to avoid these problems, the content of the first protective film forming agent in the polishing composition is preferably 0.001 g/L or more, and more preferably 0.01 g/L or more. On the other hand, when the content of the first protective film forming agent in the polishing composition is more than 1 g/L, and more specifically more than 0.1 g/L, a protective film is excessively formed on the surface of the conductive layer 14, with the result that the polishing of the conductive layer 14 may be excessively suppressed. Accordingly, to ensure an appropriate removal rate of polishing the conductive layer 14, the content of the first protective film forming agent in the polishing composition is preferably 1 g/L or less, and more preferably 0.1 g/L or less.

To obtain a stronger dishing suppression function, the second protective film forming agent to be contained in the polishing composition is preferably a polyoxyethylene alkylether acetate such as polyoxyethylene laurylether acetate or a polyoxyethylene alkylphenylether phosphate.

When the content of the second protective film forming agent in the polishing composition is less than 0.05 g/L, more specifically less than 0.5 g/L, and even more specifically less than 1 g/L, dishing is not sufficiently suppressed. Accordingly, the content of the second protective film forming agent in the polishing composition is preferably 0.05 g/L or more, more preferably 0.5 g/L or more, and most preferably 1 g/L or more. On the other hand, when the content of the second protective film forming agent in the polishing composition is more than 50 g/L, more specifically more than 30 g/L and even more specifically more than 15 g/L, the polishing of the conductive layer 14 may be excessively suppressed. Accordingly, to ensure an appropriately removal rate of polishing the conductive layer 14, the content of the second protective film forming anent in the polishing composition is preferably 50 g/L or less, more preferably 30 g/L or less, and most preferably 15 g/L or less.

When the molecular weight of the second protective film forming agent contained in the polishing composition is less than 200, and more specifically less than 400, dishing suppression function may not be so strong. Accordingly, to obtain a stronger dishing suppression function, the molecular weight of the second protective film forming agent contained in the polishing composition is preferably 200 or more, and more preferably 400 or more. On the other hand, when the molecular weight of the second protective film forming agent is more than 1000, and more specifically more than 700, the second protective film forming agent may be less dissolved in water. Accordingly, to improve the solubility of the second protective film forming agent in the polishing composition, the molecular weight of the second protective film forming agent contained in the polishing composition is preferably 1000 or less, and more preferably 700 or less.

If the number of repeat units in a polyoxyethylene group, polyoxypropylene group, or poly(oxyethylene/oxypropylene) group in the second protective film forming agent is less than 2, and more specifically less than 3, the second protective film forming agent is less soluble in water. Accordingly, to improve the solubility of the second protective film forming agent in the polishing composition, the number of repeat units in a polyoxyethylene group, polyoxypropylene group, or poly(oxyethylene/oxypropylene) group in the second protective film forming agent is preferably 2 or more, and more preferably 3 or more.

If the HLB (hydrophilicity/lipophilicity balance) value of the second protective film forming agent is less than 10, and more specifically less than 11.5, the second protective film forming agent may be less dissolved in water, leading in an emulsion state. This is not desirable in forming a uniform protective film on an object to be polished. Accordingly, to improve the solubility of the second protective film forming agent in the polishing composition, the HLB value of the second protective film forming agent contained in the polishing composition is preferably 10 or more, and more preferably 11.5 or more. On the other hand, the HLB value of the second protective film forming agent contained in the polishing composition is more than 16, and more specifically more than 14, dishing suppression function may not be so strong. Accordingly, to obtain a stronger dishing suppression function, the HLB value of the second protective film forming agent contained in the polishing composition is preferably 16 or less, and more preferably 14 or less. The HLB value of the second protective film forming agent is obtained, for example, by the griffin method.

The oxidant has a function of oxidizing an object to be polished and contributes to improving the performance of the polishing composition for polishing the conductive layer 14 through oxidation of the conductive layer 14. To reduce metallic contamination of an object derived from an oxidant, the oxidant contained in the polishing composition is preferably hydrogen peroxide.

When the content of an oxidant in the polishing composition is less than 0.3 g/L, more specifically less than 1.5 g/L, and even more specifically less than 3 g/L, the performance of the polishing composition for polishing the conductive layer 14 may not be improved so much. Accordingly, to polish the conductive layer 14 at a higher removal rate, the content of an oxidant in the polishing composition is preferably 0.3 g/L or more, more preferably 1.5 g/L or more, and most preferably 3 g/L or more. On the other hand, when the content of an oxidant in the polishing composition is more than 30 g/L, more specifically more than 15 g/L, and even more specifically more than 10 g/L, the performance of the polishing composition for polishing the conductive layer 14 is excessively high, with the result that dishing is likely to occur. Accordingly, to suppress dishing, the content of an oxidant in the polishing composition is preferably 30 g/L or less, more preferably 15 g/L or less, and most preferably 10 g/L or less.

The etching agent has a function of etching an object to be polished and contributes to improving the performance of the polishing composition for polishing the conductive layer 14 through the etching of the conductive layer 14. The etching agent to be contained in the polishing composition may be an α-amino acid such as glycine, alanine, or valine. Of them, glycine is preferable to polish the conductive layer 14 at a higher removal rate.

When the content of an etching agent in the polishing composition is less than 0.5 g/L, more specifically less than 1 g/L, and even more specifically less than 3 g/L, the performance of the polishing composition for polishing the conductive layer 14 may not be improved so much. Accordingly, to polish the conductive layer 14 at a higher removal rate, the content of an etching agent in the polishing composition is preferably 0.5 g/L or more, more preferably 1 g/L or more, and most preferably 3 g/L or more. On the other hand, when the content of an etching agent in the polishing composition is more than 50 g/L, more specifically more than 30 g/L, and even more specifically more than 10 g/L, the performance of the polishing composition for polishing the conductive layer 14 is excessively high, with the result that dishing is likely to occur. Accordingly, to suppress dishing, the content of an etching agent in the polishing composition is preferably 50 g/L or less, more preferably 30 g/L or less, and most preferably 10 g/L or less.

The abrasive grains play a role in mechanically polishing an object and contribute to improving the performance of the polishing composition for polishing the conductive layer 14. The abrasive grains to be contained in the polishing composition may be silica such as powdered calcined silica, fumed silica, or colloidal silica, or alumina such as colloidal alumina. To reduce surface defects of an object after being polished, silica is preferable. Of them, colloidal silica is particularly preferable.

When the content of abrasive grains in the polishing composition is less than 0.01 g/L, more specifically less than 0.05 g/L, and even more specifically less than 0.1 g/L, the performance of the polishing composition for polishing the conductive layer 14 is not much improved. Accordingly, to polish the conductive layer 14 at higher removal rates, the content of abrasive grains in the polishing composition is preferably 0.01 g/L or more, more preferably 0.05 g/L or more, and most preferably 0.1 g/L or more. On the other hand, the content of abrasive grains in the polishing composition is more than 200 g/L, more specifically more than 20 g/L, and even more specifically more than 10 g/L, the performance of the polishing composition for polishing the conductive layer 14 is excessively high, with the result that dishing is likely to occur. Accordingly, to suppress dishing, the content of abrasive grains in the polishing composition is preferably 200 g/L or less, more preferably 20 g/L or less, and most preferably 10 g/L or less.

Abrasive grains having an average primary particle diameter of less than 1 nm hardly have performance of polishing an object. Accordingly, to polish an object at a high removal rate, the average primary particle diameter of abrasive grains contained in the polishing composition is preferably 1 nm or more. On the other hand, when the average primary particle diameter of abrasive grains contained in the polishing composition is more than 500 nm, the surface roughness increases and scratch is produced, with the result that the surface quality of an object after being polished is likely to decrease. Accordingly, to maintain the surface quality of an object after being polished, the average primary particle diameter of abrasive grains is preferably 500 nm or less. The average primary particle diameter of abrasive grains is calculated from the specific surface area of abrasive grains, which is measured, for example, by the BET method.

In particular, when the abrasive grains contained in the polishing composition is colloidal silica, the average primary particle diameter of colloidal silica contained as abrasive grains in the polishing composition may be as follows. When the average primary particle diameter of colloidal silica contained as abrasive grains in the polishing composition is less than 3 nm, and more specifically less than 6 nm, the performance of the polishing composition for polishing the conductive layer 14 is not much improved. Accordingly, to polish the conductive layer 14 at a higher removal rate, the average primary particle diameter of colloidal silica contained as abrasive grains in the polishing composition is preferably 3 nm or more, more preferably 6 nm or more. On the other hand, when the average primary particle diameter of colloidal silica contained as abrasive grains in the polishing composition is more than 200 nm, more specifically more than 100 nm, and even more specifically more than 50 nm, colloidal silica is likely to precipitate. Accordingly, to prevent precipitation of colloidal silica, the average primary particle diameter of colloidal silica contained as abrasive grains in the polishing composition is preferably 200 nm or less, more preferably 100 nm or less, and most preferably 50 nm or less.

When the pH of the polishing composition is less than 8, the conductive layer 14 may not be polished at a high removal rate or abrasive grains in the polishing composition aggregate, and thus unfavorable from a practical point of view. Accordingly, the pH of the polishing composition must be 8 or more. On the other hand, when the pH of the polishing composition is excessively high, abrasive grains in the polishing composition may be dissolved. Accordingly, to prevent dissolution of abrasive grains, the pH of the polishing composition is preferably 13 or less, and more preferably 11 or less.

According to the embodiment of the present invention, the following advantages are obtained.

A polishing composition according to the embodiment contains, in addition to at least one type of compound selected from benzotriazole and a benzotriazole derivative, at least one type of compound selected from compounds represented by the general formulas (1) and (2), as a protective film forming agent for suppressing dishing. Therefore, a polishing composition according to the embodiment suppresses dishing more strongly, compared to conventional polishing compositions, which contain benzotriazole as a protective film forming agent but do not contain at least one type of compound selected from compounds represented by the general formulas (1) and (2). Accordingly, a polishing composition according to the embodiment is suitably used in polishing for forming wiring a semiconductor device.

The aforementioned embodiment may be modified as follows.

The abrasive grains to be contained in a polishing composition according to the embodiment may be eliminated. In this case, it is possible to maintain the performance of the polishing composition for polishing the conductive layer 14 due to the functions of an etching agent and an oxidant contained in the polishing composition. To polish the conductive layer 14 at a higher removal rate, abrasive grains are preferably contained in a polishing composition.

To a polishing composition according to the embodiment, a compound (nonionic surfactant) represented by the general formula (3) below may be added. When a compound represented by the general formula (3) is added, the performance of the polishing composition for polishing the conductive layer 14 is improved. Although a compound represented by the general formula (3) has a function for forming a protective film on the surface of an object to be polished similarly to the compositions represented by the general formulas (1) and (2), the protective film formed of a compound represented by the general formula (3) is low in protecting function than those formed of the compounds represented by the general formulas (1) and (2). Therefore, when a compound represented by the general formula (3) is added to a polishing composition according to the embodiment, a protective film formed of a compound represented by the general formula (3) and relatively low in protecting function partly replaces a protective film formed of a compound represented by the general formula (1) or (2) and having a relatively high protecting function for a polishing composition according to the embodiment. This may be considered as a reason why the performance of a polishing composition for polishing the conductive layer 14 is improved by adding a compound represented by the general formula (3) to the polishing composition. To polish the conductive layer 14 at a higher removal rate, a compound represented by the general formula (3) to be contained in the polishing composition is preferably a polyoxyethylene alkylether such as polyoxyethylene laurylether.

ROR′ (3)

In the formula (3), R represents an alkyl group or an alkylphenyl group, and R′ represents a polyoxyethylene group or a polyoxypropylene group.

When the content of a compound represented by the general formula (3) in the polishing composition is more than 50 g/L, more specifically more than 10 g/L, and even more specifically more than 5 g/L, the dishing suppression function by compounds represented by the general formulas (1) and (2) may be reduced. As a result, dishing is likely to occur. In addition, the performance of the polishing composition for polishing the conductive layer 14 may decrease. To avoid these problems, the content of a compound represented by the general formula (3) in the polishing composition is preferably 50 g/L or less, more preferably 10 g/L or less, and most preferably 5 g/L or less.

When the molecular weight of a compound represented by the general formula (3) contained in the polishing composition is less than 300, more specifically less than 400 and even more specifically less than 500, the performance of the polishing composition for polishing the conductive layer 14 may not be improved so much. Accordingly, to polish the conductive layer 14 at a higher removal rate, the molecular weight of a compound represented by the general formula (3) contained in the polishing composition is preferably 300 or more, more preferably 400 or more, and most preferably 500 or more. On the other hand, when the molecular weight of a compound represented by the general formula (3) is more than 1500, more specifically more than 1200, and even more specifically more than 1000, the compound is less soluble in water. In addition, when the molecular weight of a compound represented by the general formula (3) is as large as mentioned above, the performance of the polishing composition for polishing the conductive layer 14 may decrease. Accordingly to avoid these problems, the molecular weight of a compound represented by the general formula (3) is preferably 1500 or less, more preferably 1200 or less, and most preferably 1000 or less.

When the HLB value of a compound represented by the general formula (3) contained in the polishing composition is less than 13, and more specifically less than 14, the performance of the polishing composition for polishing the conductive layer 14 may not be improved so much Accordingly, to polish the conductive layer 14 at a higher removal rate, the HLB value of a compound represented by the general formula (3) contained in the polishing composition is preferably 13 or more, and more preferably 14 or more. On the other hand, when the HLB value of a compound represented by the general formula (3) contained in the polishing composition is more than 18, and more specifically more than 17, the dishing suppression function by compounds represented by the general formulas (1) and (2) may be reduced, with the result that dishing is likely to occur. Accordingly, to suppress dishing, the HLB value of a compound represented by the general formula (3) contained in the polishing composition is preferably 18 or less, and more preferably 17 or less. The HLB value of a compound represented by the general formula (3) is obtained, for example, by the griffin method.

To a polishing composition according to the embodiment, a pH adjusting agent may be added, if necessary. The pH adjusting agent to be added to the polishing composition may be arbitrarily chosen. However, an alkali metal hydroxide such as potassium hydroxide or an alkali such as ammonia is preferably used, since the performance of the polishing composition for polishing the conductive layer 14 improves.

A polishing composition according to the aforementioned embodiment may be prepared by diluting a concentrated stock solution before use. The concentration rate of the stock solution is preferably 3 fold or less.

To a polishing composition according to the embodiment, known additives such as a preservative and a defoaming agent may be added as needed.

Examples of the present invention and Comparative Examples will now be described.

Benzotriazole, polyoxyethylene laurylether acetate or an alternative compound thereof, polyoxyethylene laurylether, a 31% aqueous hydrogen peroxide solution, glycine, colloidal silica sol, and a pH adjusting agent were appropriately blended and, if necessary, diluted with water to prepare polishing compositions of Examples 1 to 19 and Comparative Examples 1 to 12. The details of benzotriazole, polyoxyethylene laurylether acetate or the alternative compound thereof, polyoxyethylene lauryl ether, a 31% aqueous hydrogen peroxide solution, glycine, colloidal silica, and a pH adjusting agent in each of the polishing compositions, as well as pH of each polishing composition are shown in Table 1.

The numeral values shown in the column “Removal rate” of Table 1 indicate the removal rates when a copper blanket wafer of 200 mm in diameter was polished by use of the polishing compositions of Examples 1 to 19 and Comparative Examples 1 to 12 under the position conditions shown in Table 2. The removal rate of each wafer was obtained by dividing the difference in thickness of the wafer between before and after polishing by polishing time. The thickness of the wafer was measured by a sheet resistance measuring apparatus “VR-120” manufactured by International Electric System Service.

The numerical values shown in the column “Dishing” of Table 1 indicate the amounts of dishing of a copper pattern wafer (854 mask pattern) manufactured by SEMATEC when it was polished by use of each of the polishing compositions of Examples 1 to 19 and Comparative Examples 1 to 12. More specifically, the copper pattern wafer manufactured by SEMATEC is formed by providing a tantalum barrier layer and a copper conductive layer having a thickness of 10,000 Å successively in this order on a silicon dioxide insulating layer having trenches and has an initial depressed portion of 5,000 Å in depth in the upper surface. Before the copper pattern wafer was polished by use of each of the polishing compositions of Examples 1 to 19 and Comparative Examples 1 to 12, the wafer was subjected to preliminary polishing using a polishing material “PLANERLITE-7105” manufactured by Fujimi Incorporated under the conditions shown in table 2 until the thickness of the conductive layer was reduced to 300 nm. Subsequently, the copper pattern wafer thus preliminary polished was subjected to polishing using each of the polishing compositions of Examples 1 to 19 and Comparative Examples 1 to 12 under the conditions shown in Table 2 until the upper layer of the barrier layer was exposed. Thereafter, the amount of dishing was measured by use of a contact-type surface measurement apparatus, profiler “HRP340” manufactured by KLA Tencor Corporation in the region of each wafer in which trenches of 100 μm width are independently formed.

The reference symbols shown in the column “Dispersion stability” of Table 1 indicate the evaluation results of dispersion stability with respect to the polishing compositions of Examples 1 to 19 and Comparative Examples 1 to 12. More specifically, the polishing compositions of Examples 1 to 19 and Comparative Examples 1 to 12 were allowed to stand in a thermostatic chamber of 80° C. for 30 days and then aggregation and precipitation were observed. Based on the observation results, the dispersion stability of the polishing compositions was evaluated. Reference symbol ∘ in the column “Dispersion stability” represents that neither aggregation nor precipitation were observed and reference symbol x represents that aggregation or precipitation was observed.

TABLE 1

| | | (B) | | | | | | | | | | | |
|---|---|---|---|---|---|---|---|---|---|---|---|---|---|
| | | Polyoxyethylene | | | | | | | | | | | |
| | | laurylether | | | 31% | | | (G) | | | | | |
| | (A) | acetate or | | | aqueous | | (F) | pH | | | | | |
| | Benzo- | alternative | | Polyoxyethylene | hydrogen | (E) | Colloidal | adjusting | | | Removal | | |
| | triazole | compound | | laurylether | peroxide | Glycine | silica | agent | | | rate | | Dis- |
| | Content | | Content | Content | Content | Content | Content | | Content | | [nm/ | Dishing | persion |
| | [g/L] | Name | [g/L] | [g/L] | [g/L] | [g/L] | [g/L] | Name | [g/L] | pH | min.] | [nm] | stability |
| Ex. 1 | 0.08 | B1 | 3.5 | 0 | 15 | 5 | 1 | G1 | 3.5 | 9.2 | 390 | 55 | ∘ |
| Ex. 2 | 0.08 | B1 | 3.5 | 0 | 15 | 5 | 3 | G1 | 3.5 | 9.2 | 383 | 58 | ∘ |
| Ex. 3 | 0.08 | B1 | 3.5 | 0 | 15 | 5 | 5 | G1 | 3.5 | 9.2 | 400 | 63 | ∘ |
| Ex. 4 | 0.08 | B1 | 3.5 | 0 | 15 | 5 | 3 | G1 | 4 | 9.6 | 395 | 78 | ∘ |
| Ex. 5 | 0.04 | B1 | 3.5 | 0 | 15 | 5 | 3 | G1 | 3.5 | 9.2 | 450 | 70 | ∘ |
| Ex. 6 | 0.06 | B1 | 3.5 | 0 | 15 | 5 | 3 | G1 | 3.5 | 9.2 | 412 | 55 | ∘ |
| Ex. 7 | 0.10 | B1 | 3.5 | 0 | 15 | 5 | 3 | G1 | 3.5 | 9.2 | 304 | 43 | ∘ |
| Ex. 8 | 0.08 | B1 | 3.5 | 0 | 15 | 4 | 3 | G1 | 3.5 | 9.6 | 361 | 55 | ∘ |
| Ex. 9 | 0.08 | B1 | 3.5 | 0 | 20 | 5 | 3 | G1 | 3.5 | 9.0 | 357 | 60 | ∘ |
| Ex. 10 | 0.08 | B1 | 2.5 | 0 | 15 | 5 | 3 | G1 | 3.5 | 9.2 | 387 | 67 | ∘ |
| Ex. 11 | 0.08 | B1 | 3.5 | 1.0 | 15 | 5 | 3 | G1 | 3.5 | 9.2 | 450 | 62 | ∘ |
| Ex. 12 | 0.08 | B1 | 4.5 | 1.0 | 15 | 5 | 3 | G1 | 3.5 | 9.2 | 430 | 58 | ∘ |
| Ex. 13 | 0.08 | B1 | 3.5 | 2.0 | 15 | 5 | 3 | G1 | 3.5 | 9.2 | 440 | 60 | ∘ |
| Ex. 14 | 0.08 | B1 | 4.5 | 2.0 | 15 | 5 | 3 | G1 | 3.5 | 9.2 | 430 | 70 | ∘ |
| Ex. 15 | 0.08 | B1 | 3.5 | 3.0 | 15 | 5 | 3 | G1 | 3.5 | 9.2 | 440 | 80 | ∘ |
| Ex. 16 | 0.08 | B1 | 4.5 | 3.0 | 15 | 5 | 3 | G1 | 3.5 | 9.2 | 425 | 75 | ∘ |
| Ex. 17 | 0.08 | B1 | 3.5 | 0 | 15 | 5 | 3 | G2 | 3.5 | 8.9 | 350 | 55 | ∘ |
| Ex. 18 | 0.08 | B1 | 3.5 | 2.0 | 15 | 5 | 3 | G2 | 3.5 | 8.9 | 395 | 68 | ∘ |
| Ex. 19 | 0.08 | B1 | 3.5 | 0 | 15 | 5 | 0 | G1 | 3.5 | 9.2 | 120 | 65 | ∘ |
| C. Ex. 1 | 0.08 | — | 0 | 0 | 15 | 5 | 3 | G1 | 3.5 | 9.0 | 550 | 200 | ∘ |
| C. Ex. 2 | 0.40 | — | 0 | 0 | 15 | 5 | 3 | G1 | 3.5 | 9.0 | 298 | 150 | ∘ |
| C. Ex. 3 | 1.00 | — | 0 | 0 | 15 | 5 | 3 | G1 | 3.5 | 9.0 | 187 | 135 | ∘ |
| C. Ex. 4 | 0.08 | — | 0 | 0 | 15 | 5 | 3 | — | 0 | 6.5 | 500 | 200 | ∘ |
| C. Ex. 5 | 1.00 | — | 0 | 0 | 15 | 5 | 3 | — | 0 | 6.5 | 80 | 140 | ∘ |
| C. Ex. 6 | 1.00 | — | 0 | 0 | 15 | 20 | 3 | — | 0 | 6.5 | 135 | 160 | ∘ |
| C. Ex. 7 | 0.08 | B1 | 3.5 | 0 | 15 | 5 | 3 | — | 0 | 6.5 | 10 | 50 | ∘ |
| C. Ex. 8 | 0.08 | B2 | 0 | 0 | 15 | 5 | 3 | G1 | 3.5 | 9.3 | 550 | 150 | ∘ |
| C. Ex. 9 | 0.08 | B3 | 0 | 0 | 15 | 5 | 3 | G1 | 3.5 | 9.1 | 600 | 203 | ∘ |
| C. Ex. 10 | 0.08 | B1 | 3.5 | 0 | 15 | 5 | 3 | G3 | 3.5 | 3.3 | 150 | 134 | x |
| C. Ex. 11 | 0.08 | B1 | 3.5 | 0 | 15 | 5 | 3 | G3 | 3.5 | 3.1 | 83 | 126 | x |
| C. Ex. 12 | 0.08 | B1 | 3.5 | 0 | 15 | 5 | 3 | G4 | 3.5 | 3.3 | 90 | 160 | x |

In Table 1, reference symbol B1 represents polyoxyethylene laurylether acetate, B2 represents coconut oil fatty acid sarcosine triethanolamine, B3 represents ammonium polyoxyethylene laurylether sulfate, G1 represents potassium hydroxide, G2 represents ammonia, G3 represents glycol acid, and G4 represents sulfuric acid.

Polyoxyethylene lauryl ether acetate used in Examples and Comparative Examples has a molecular weight of 441, the number of repeat units in a polyoxyethylene group is 2.5 and an HLB value of 12.2. Coconut oil fatty acid sarcosine triethanolamine used in Comparative Examples has a molecular weight of 444 and an HLB value of 9.8. Ammonium polyoxyethylene laurylether sulfate used in Comparative Examples has a molecular weight of 374.5 and the number of repeat units in a polyoxyethylene group is 2 and an HLB value of 10.9. Polyoxyethylene laurylether used in Examples has a molecular weight of 802 and an HLB value of 15.8.

TABLE 2

| | |
|---|---|
| Polishing machine: | Single-sided CMP polishing machine |
| | “Mirra” manufactured by Applied |
| | Materials Inc. |
| Polishing pad: | laminate polishing pad “IC-1000/ |
| | Suba IV” made of polyurethane and |
| | manufactured by Rohm and Haas |
| Polishing pressure: | about 28 kPa (=2 psi) |
| Rotation speed of machine platen: | 100 rpm |
| Feed speed of polishing | 200 mL/min |
| composition: | |
| Carrier rotation speed: | 100 rpm |

As shown in Table 1, the polishing compositions of Examples 1 to 19 provided a dishing amount of 100 nm or less, a removal rate of not less than 100 nm/minute. The results of dishing and removal rate were practically satisfactory. In addition, the polishing compositions of Examples 1 to 19 provided satisfactory results with respect to the storage stability. In contrast, in the polishing compositions of Comparative Examples 1 to 12, the results of either one of removal rate and dishing were unsatisfactory.

1. A polishing composition comprising:
a protective film forming agent;
an oxidant; and
an etching agent,
wherein the protective film forming agent contains at least one type of compound selected from benzotriazole and a benzotriazole derivative, and at least one type of compound selected from the compounds represented by the general formula ROR′COOH and the general formula ROR′OPO₃H₂ (where R represents an alkyl group or an alkylphenyl group, and R′ represents a polyoxyethylene group, polyoxypropylene group, or poly(oxyethylene/oxypropylene) group), and the pH of the polishing composition is 8 or more.

2. The polishing composition according to claim 1, wherein said at least one type of compound selected from the compounds represented by the general formula ROR′COOH and the general formula ROR′OPO₃H₂ is a polyoxyethylene alkylether acetate or a polyoxyethylene alkylphenylether phosphate.

3. The polishing composition according to claim 1, further comprising a compound represented by the general formula ROR′ (where R represents an alkyl group or an alkylphenyl group, and R′ represents a polyoxyethylene group or a polyoxypropylene group).

4. The polishing composition according to claim 3, wherein the compound represented by the general formula ROR′ is a polyoxyethylene alkylether.

5. The polishing composition according to claim 1, further comprising abrasive grains.

6. The polishing composition according to claim 1, further comprising an alkali.
